(19) United States
(12) Patent Application Publication
(10) Pub. No.: US 2021/0016597 A1
(43) Pub. Date: Jan. 21, 2021

(54) COLLAPSIBLE WRITING BOARD AND METHOD OF USING A COLLAPSIBLE WRITING BOARD

(71) Applicant: Zinatt Technologies, Inc., Tucson, AZ (US)

(72) Inventor: Gabriel Enrique Reina, Tucson, AZ (US)

(21) Appl. No.: 16/932,979

(22) Filed: Jul. 20, 2020

Related U.S. Application Data
(60) Provisional application No. 62/876,085, filed on Jul. 19, 2019.

(51) Int. Cl. B43L 1/12; A47B 97/00

(52) U.S. Cl. CPC B43L 1/123; B43L 1/008; A47B 97/001

(57) ABSTRACT

A collapsible writing board is provided comprising: a sheet of writing material with a writing surface; a plurality of rigid elongate segments affixed to the sheet; and at least one segment connector affixed to each rigid elongate segment; wherein the at least one segment connector provides planar support to enable the rigid elongate segments to assemble into a first state, such that the rigid elongate segments are substantially aligned on a support plane to support the sheet of writing material, and to assemble into a second state, such that the rigid elongate segments are unaligned from the support plane, to facilitate storage of the collapsible writing board.

### TECHNICAL FIELD

The present disclosure relates generally to writing boards, and more particularly to collapsible writing boards.

### BACKGROUND OF THE DISCLOSURE

Writing boards, for example dry-erase boards, are often located in offices and classrooms. A writing board provides a large writing surface and facilitates audience interaction during meetings, for example, for brainstorming and innovation sessions. Dry-erase boards allow information to be erased. Paper boards are also used. Paper boards facilitate removal of successive sheets of paper from stack of sheets. The removed sheets are then often hung for the audience to see. A drawback of known writing boards is that they are not designed for ease of transportation between different locations. To the extent that a writing board is transportable, it is typically supported, in use, by a foldable tripod that has to be transported with the board. Upon expansion, two legs of the tripod provide support for horizontal writing forces applied while writing on the writing board. Two protrusions may extend from the legs to provide support against gravity. Another version includes a structure having wheels designed to roll the structure and writing board in an office or conference room. Large permanent writing boards are often found secured to walls.

There is a need for a writing board that offers the benefits of a large writing board that is easy to transport and/or store.

### SUMMARY OF DISCLOSED EMBODIMENTS

In one embodiment, a collapsible writing board is provided comprising: a sheet of writing material with a writing surface; a plurality of rigid elongate segments including or affixed to the sheet; and at least one segment connector affixed to each rigid elongate segment; wherein the at least one segment connector provides planar support to enable the rigid elongate segments to assemble into a first state, such that the rigid elongate segments are substantially aligned on a support plane to support the sheet of writing material, and to assemble into a second state, such that the rigid elongate segments are unaligned from the support plane, to facilitate storage of the collapsible writing board. In one aspect of this embodiment, the sheet of writing material comprises a flexible material suitable for use with standard dry-erase markers having a composition that inhibits creasing or cracking. Another aspect further includes a plurality of hangers configured to releasably secure the collapsible writing board to a structure. Another aspect further includes a plurality of magnets configured to releasably secure the collapsible writing board to a structure. Another aspect further includes at least one hook formed on a first rigid elongate segment configured to releasably secure the collapsible writing board to a structure. In a variant of this aspect, the at least one hook is formed by a slot formed into at least a portion of a length of the first rigid elongate segment. In another aspect of this embodiment, the segment connectors include magnetic strips affixed along a length of at least one face of each rigid elongate segment to allow positioning of the rigid elongate segments into the first and second states. In yet another aspect, the segment connectors include magnetic dots affixed substantially at intervals along a length of at least one face of each rigid elongate segment to allow assembly of the rigid elongate segments into the first and second states. In still another aspect, the segment connectors include flexible hinges affixed substantially at intervals along a length of at least one face of each rigid elongate segment to allow assembly of the rigid elongate segments into the first and second states. In a further aspect, the segment connectors include snap hinges affixed substantially at intervals along a length of at least one face of each rigid elongate segment to allow assembly of the rigid elongate segments into the first and second states.

In another embodiment, a writing board configured to collapse for transport and/or storage is provided, comprising: a sheet of writing material with a writing surface; rigid elongate segments including or coupled to the sheet in substantially parallel relationship to one another; segment connectors coupled between adjacent rigid elongate segments; wherein the segment connectors are movable between an expanded state wherein the segment connectors support adjacent rigid elongate segments in substantially the same plane such that the writing board can be used and a collapsed state wherein the segment connectors support the adjacent rigid elongate segments in a partially overlapping orientation such that the writing board can be transported and/or stored. In one aspect of this embodiment, the sheet of writing material includes a flexible material suitable for use with standard dry-erase markers. Another aspect further comprises at least one hanger attached to at least one rigid elongate segment, the at least one hanger being configured to suspend the writing board from a structure attached to a vertical support surface. In a variant of this aspect, the at least one hanger includes a hinged hook coupled to a hanger base attached to the at least one rigid elongate segment. Another aspect further includes at least one hanger formed in at least one rigid elongate segment and having an unhinged hook configured to suspend the writing board from a structure attached to a vertical support surface. In still another aspect, the segment connectors include magnetic strips coupled along a length of at least one face of each rigid elongate segment, adjacent magnetic strips being coupled to one another when the segment connectors are in the expanded state and the adjacent magnetic strips being uncoupled from one another when the segment connectors are in the collapsed state. In another aspect, the segment connectors include magnetic dots coupled at intervals along a length of at least one face of each rigid elongate segment.

In still another embodiment, a method of using a collapsible writing board is provide, comprising: unfolding the collapsible writing board from a collapsed state wherein adjacent rigid elongate segments of a plurality of rigid elongate segments coupled to a writing surface are in an at least partially overlapping orientation relative to one another; bringing the plurality of rigid elongate segments into substantial alignment with one another such that the writing surface is substantially planar; and folding the collapsible writing board into the collapsed state for transport and/or storage. One aspect of this embodiment further includes suspending the collapsible writing board from a vertical support surface after bringing the plurality of rigid elongate segments into substantial alignment. Another aspect further includes placing the collapsible writing board into a storage bag after folding the collapsible writing board into the collapsed state.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the disclosure taken in conjunction with the accompanying drawings, wherein:

FIG. 1 is a back view of an embodiment of a collapsible writing board in an open position;

FIG. 2 is an enlarged view of a section of the collapsible writing board of FIG. 1;

FIG. 3 is a side view of the collapsible writing board of FIG. 1;

FIGS. 4 and 5 are sectional side views of the collapsible writing board of FIG. 1 showing a stationary hook and a hinged hook, with the hinged hook in a partially deployed position (FIG. 4) and a fully deployed position (FIG. 5);

FIG. 6 a sectional side view of the writing board of FIG. 1 showing the stationary hook and the hinged hook undeployed positions;

FIG. 7 is a side view of a writing board according to the present disclosure in a partially collapsed state;

FIG. 8 is a side view of the writing board of FIG. 7 in a fully collapsed state;

FIG. 9 is a side view of the writing board of FIG. 8 in a storage bag;

FIG. 10 is a sectional side view of another embodiment of a collapsible writing board in a partially collapsed state;

FIG. 11 is a sectional side view of the writing board of FIG. 10 in a fully collapsed state;

FIG. 12 is a side view of the writing board of FIG. 11 in a storage bag;

FIG. 13 is a sectional back view of the writing board of FIG. 1 in an open position showing rigid segments connected by magnetic strips;

FIG. 14 is a sectional back view of another embodiment of a writing board in an open position showing rigid segments connected by magnetic dots;

FIG. 15 is a sectional back view of another embodiment of a writing board in an open position showing rigid segments connected by flexible hinges; and

FIG. 16 is a sectional back view of another embodiment of a writing board in an open position showing rigid segments connected by snap hinges.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings.

The terms “couples,” “coupled,” and variations thereof are used to include both arrangements wherein two or more components are in direct physical contact and arrangements wherein the two or more components are not in direct contact with each other (e.g., the components are “coupled” via at least a third component), but yet still cooperate or interact with each other. Furthermore, the terms “couples,” “coupled,” and variations thereof refer to any connection for machine parts known in the art, including, but not limited to, connections with bolts, screws, threads, magnets, electro-magnets, adhesives, friction grips, welds, snaps, clips, etc.

Throughout the present disclosure and in the claims, numeric terminology, such as first and second, is used in reference to various components or features. Such use is not intended to denote an ordering of the components or features. Rather, numeric terminology is used to assist the reader in identifying the component or features being referenced and should not be narrowly interpreted as providing a specific order of components or features.

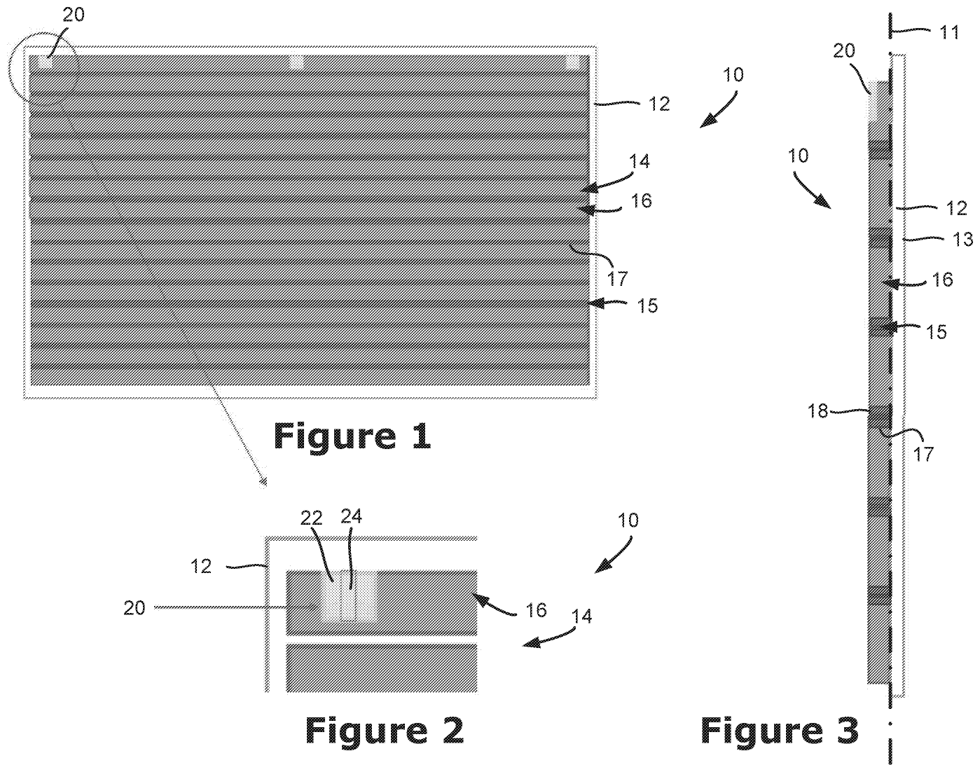

Referring now to FIGS. 1 through 3, one embodiment of a collapsible writing board 10 includes a sheet 12 having a writing surface 13, a collapsible structure 14 including rigid elongate segments 16 secured to sheet 12 in substantially parallel relationship to one another and having segment connectors 15 disposed along the length of adjacent rigid elongate segments 16, and at least one hanger 20. Segment connectors 15 and sheet 12 cooperate to enable alignment of rigid segments 16 in substantially parallel relationship to one another in a support plane 11 when collapsible writing board 10 is in a fully deployed state, and to enable collapsible writing board 10 to be rolled into a collapsed state such that rigid elongate segments 16 are unaligned from support plane 11 and adjacent rigid elongate segments at least partially overlap one another. In the collapsed state, collapsible writing board 10 can be easily transported and/or stored as is further described below. In the present embodiment, segment connectors 15 include magnetic strips 18 (FIG. 3), which are placed along opposing faces 17 of rigid elongate segments 16. Magnetic strips 18 provide planar support to enable rigid elongate segments 16 to assemble into the open position seen in FIG. 3 (i.e., when writing board 10 is in its fully deployed state). At least one hanger 20 is provided to enable suspending collapsible writing board 10 from a vertical support surface as is further described below.

It should be understood that in alternative embodiments rigid elongate segments 16 are made of or include magnetic material positioned to permit collapsible writing board 10 to be hung from a metallic surface and hanger 20 may or may not be omitted. In other embodiments, magnetic strips 18 are configured to attach magnetically to a metallic surface. In still other embodiments, instead of hangers or magnets, collapsible writing board 10 includes hook-and-loop fastener material or another type of mechanical fastener configured to mate with a corresponding structure on a support surface such as a wall.

Referring now to FIG. 2, hanger 20 includes a hanger base 22 and a hinged hook 24. Hinged hook 24 is connected by a suitable hinge connection to base 22 and provides support against gravity and horizontal support so that collapsible writing board 10 does not slip or slide from a corresponding support structure onto which collapsible writing board 10 is suspended.

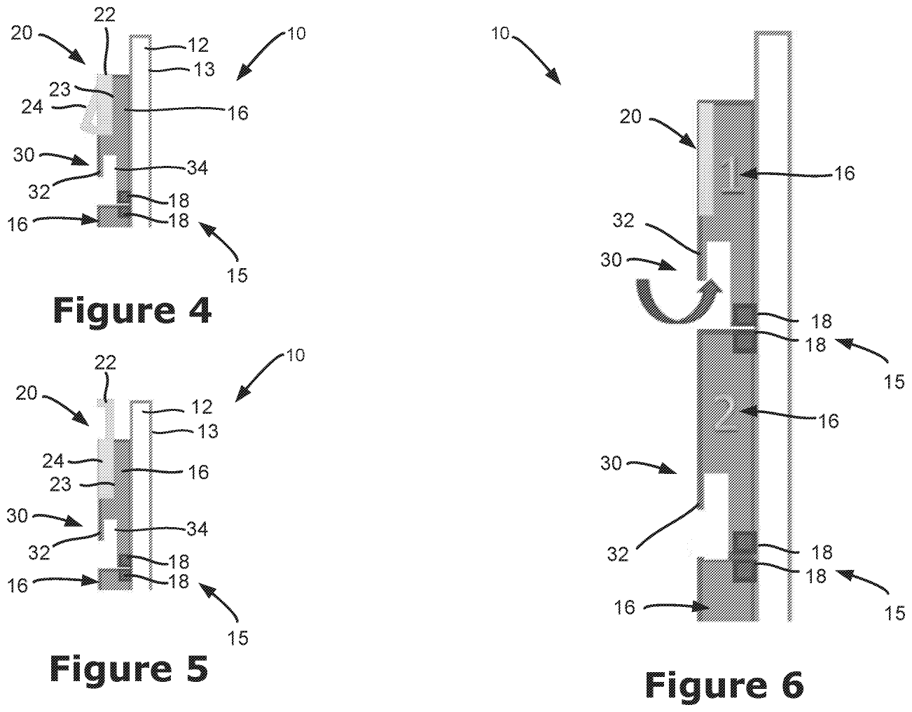

Hanger 20 may be extrusion molded and then assembled or can be machined. In on example, hanger base 22 includes a longitudinal (vertical) slot thereon that receives hook 24. A pin passing through hinged hook 24 forms the hinge that enables hinged hook 24 to move between a deployed position and a stored position. FIGS. 4 and 5 illustrate hinged hook 24 in partially and fully deployed positions, respectively. Hanger 20 is affixed to a rigid elongate segment 16 using any suitable attachment method such as, for example, mechanical fasteners or adhesive. As shown in the figures, in the illustrated embodiment a cut-out 23 is provided in the upper rigid elongate segment 16 and hanger 20 is inserted into cut-out 23 so that the rear or back facing surface of hanger base 22 is engages the rear or back facing surface of rigid elongate segment 16. It should be understood that in other embodiments of the present disclosure, hangers 20 may be replaced with magnets for applications wherein collapsible writing board 10 is to be attached to a metallic support surface. In such embodiments, the magnets may be attached to rigid elongate segments 16 using, for example, fasteners or adhesive, or a portion of rigid elongate segments 16 may be formed of metallic material. In still another embodiment, all or part of hangers 20 may be magnetic so collapsible writing board 10 may be suspended from a vertical surface using hinged hooks 24 or magnetic attraction between hangers 20 and a metallic vertical surface.

Magnetic strips 18 attach to each other when collapsible writing board 10 is expanded into the deployed or “in use” state and provide support to rigid elongate segments 16 to stabilize collapsible writing board 10. Rigid elongate segments 16 may be folded in one direction or side of plane 11 but faces 17 and magnetic strips 18 prevent collapse in the opposite side or direction.

In one example, writing surface 13 is suitable for use with dry-erase markers. Sheet 12 may be made from flexible materials suitable to be rolled or folded without causing creasing or cracking of sheet 12. Example flexible materials include vinyl, polyethylene, and paper, with and without a laminated layer of material suitable for dry-erase marking. In other embodiments, sheet 12 may be a plurality of individual segments, each having a writing surface 13, which together provide an area for writing when collapsible writing board is expanded into the deployed state. For example, each individual segment may be integral with, formed on or attached to a forward-facing surface of each rigid elongate segment 16. Thus, sheet 12 may comprise a single sheet, a laminated sheet, a composite sheet, or a plurality of individual writing surfaces. Therefore the term “sheet” denotes a large area suitable for writing thereon and is not limited to a single sheet, a single layer, or any type of material. A dry-erase marker uses an erasable ink that adheres to the writing surface without binding to or being absorbed by it.

FIGS. 4 and 5 also show another or auxiliary embodiment of a hook, denoted by numeral 32, which is made integrally with rigid elongate segments 16 to provide a hanger base to form a hanger 30 in a one-piece structure, by cutting a slot 34 along at least a portion of the length of rigid elongate segment 16. Thus, as shown, rigid elongate segment 16 may include hangers 20 and 30, including hinged hook 24 and unhinged hook 32, respectively.

Hinged hook 24 and/or unhinged hook 32 releasably secure collapsible writing board 10 to a structure such as a horizontal rod, railing, flange or a compatible protrusion from a wall or other vertical support structure.

FIG. 6 shows an embodiment including hangers in two rigid elongate segments 16. The upper rigid elongate segment 16 was described with reference to FIGS. 4 and 5. Below the upper rigid elongate segment 16 is a rigid elongate segment 16 forming another hanger 30. In this embodiment, collapsible writing board 10 may be hung from a vertical surface using either or both of hangers 30.

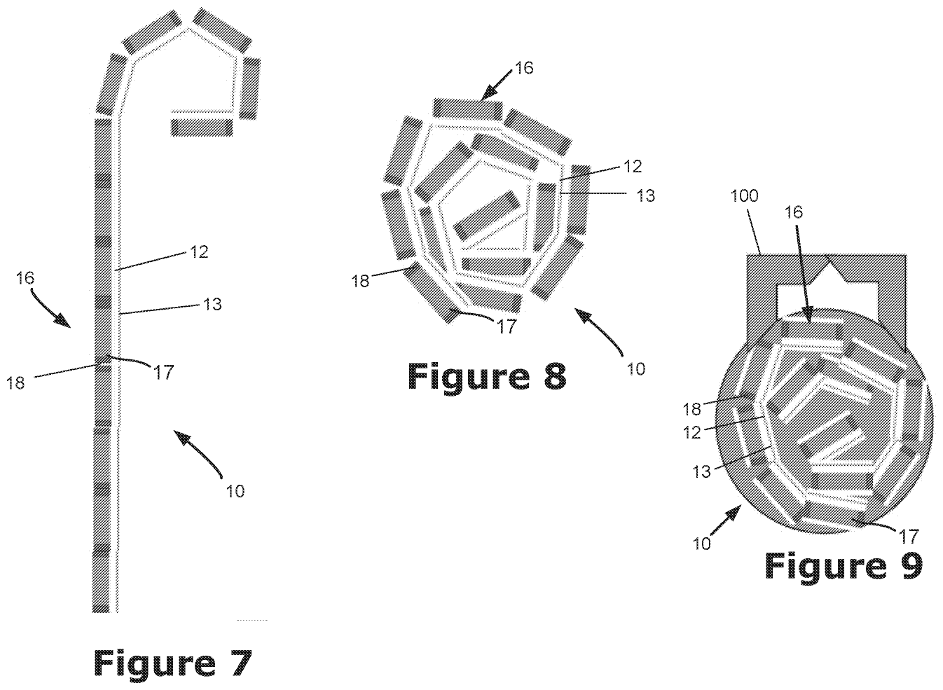

FIGS. 7 and 8 depict an embodiment of a collapsible writing board 10 being collapsed by rolling rigid elongate segments 16 into a substantially cylindrical shape for storage. FIG. 7 shows board 10 in a partially collapsed state with some of rigid elongate segments 16 slightly rolled up. FIG. 8 shows board 10 in a fully collapsed state with rigid elongate segments 16 fully rolled up. FIG. 9 shows board 10 in a fully collapsed, rolled up state and stored in a cylindrical storage bag 100.

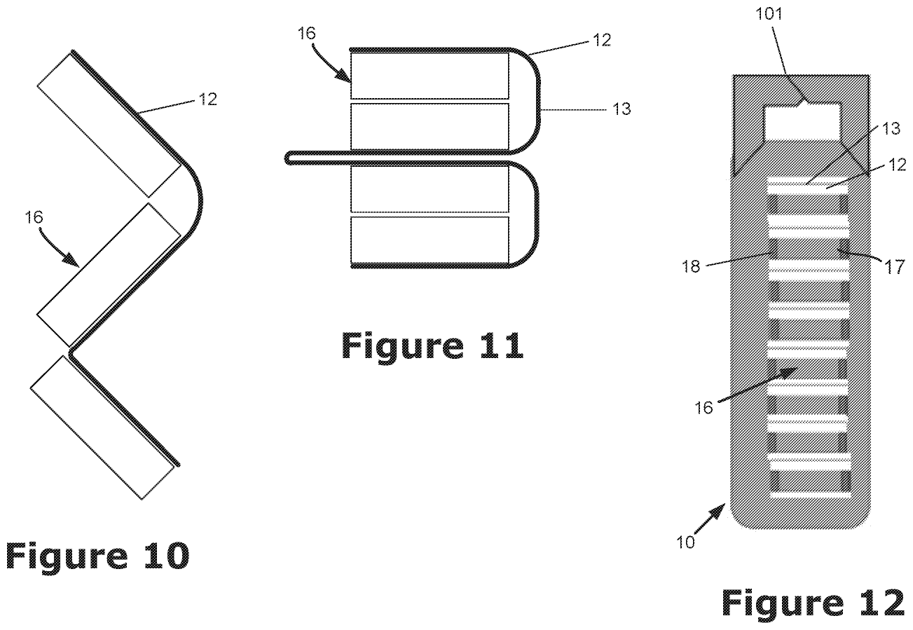

FIGS. 10 and 11 show another embodiment of a collapsible writing board 10 being collapsed by folding rigid elongate segments 16 into a substantially stacked configuration for storage. FIG. 10 shows board 10 in a partially collapsed state with rigid elongate segments 16 beginning to fold onto one another. FIG. 11 shows board 10 in a fully collapsed state with rigid elongate segments 16 fully folded into a fully collapsed state. FIG. 12 shows board 10 in a fully collapsed, folded state and stored in a rectangular storage bag 101.

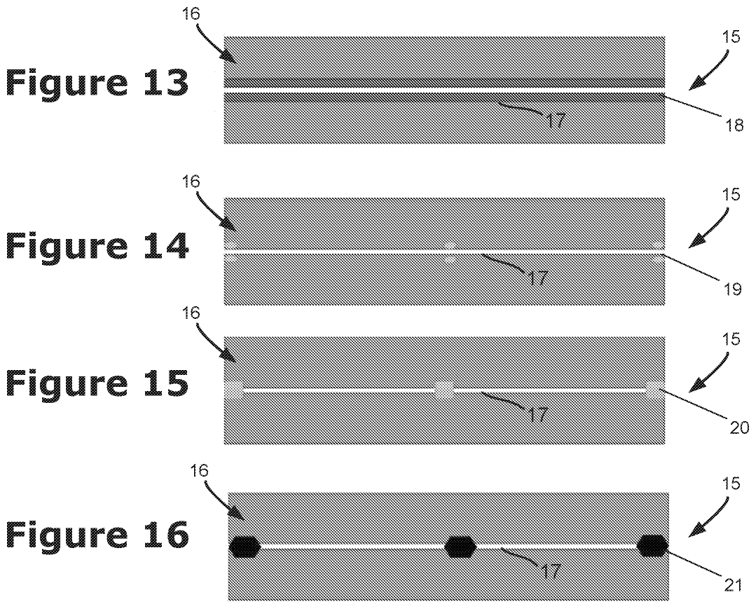

FIGS. 13-16 depict alternative embodiments of segment connectors 15 affixed to at least one face 17 of each rigid elongate segment 16, where segment connectors 15 provide planar support to enable rigid elongate segments 16 to be unfolded into an open position to support collapsible writing board 10, while also enabling rigid segments 16 to be folded into a collapsed position for storage and transport. FIG. 13 shows an embodiment wherein segment connectors 15 are magnetic strips 18 affixed along the length of at least one face 17 of each of rigid elongate segments 16. FIG. 14 shows an embodiment wherein segment connectors 15 are magnetic dots 19 affixed substantially at intervals along the length of at least one face 17 of each of rigid elongate segments 16. FIG. 15 shows an embodiment wherein segment connectors 15 are flexible hinges 20 affixed substantially at intervals along the length of at least one face 17 of each of rigid elongate segments 16. Finally, FIG. 16 shows an embodiment wherein segment connectors 15 are snap hinges 21 affixed substantially at intervals along the length of at least one face 17 of each of rigid elongate segments 16. The different embodiments of segment connectors 15 make collapsible writing board 10 amenable to different storage configurations such as rolling, folding, and stacking.

Except where a contrary intent is expressly stated, the terms “comprise,” “comprises,” “comprising,” and “having” and the like mean “include,” “includes,” “including,” and the like, and are generally interpreted to be open ended transition terms. The recitation of components, structures, steps, or the like specifically listed following an open-ended transition term in no way limit such claim to the components, structures, steps, or the like specifically listed.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic with the benefit of this disclosure in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.”

What is claimed is:

1. A collapsible writing board, comprising:
a sheet of writing material with a writing surface;
a plurality of rigid elongate segments including or affixed to the sheet; and
at least one segment connector affixed to each rigid elongate segment;
wherein the at least one segment connector provides planar support to enable the rigid elongate segments to assemble into a first state, such that the rigid elongate segments are substantially aligned on a support plane to support the sheet of writing material, and to assemble into a second state, such that the rigid elongate segments are unaligned from the support plane, to facilitate storage of the collapsible writing board.

2. The collapsible writing board of claim 1, wherein the sheet of writing material comprises a flexible material suitable for use with standard dry-erase markers having a composition that inhibits creasing or cracking.

3. The collapsible writing board of claim 1, further including a plurality of hangers configured to releasably secure the collapsible writing board to a structure.

4. The collapsible writing board of claim 1, further including a plurality of magnets configured to releasably secure the collapsible writing board to a structure.

5. The collapsible writing board of claim 1, further including at least one hook formed on a first rigid elongate segment configured to releasably secure the collapsible writing board to a structure.

6. The collapsible writing board of claim 5, wherein the at least one hook is formed by a slot formed into at least a portion of a length of the first rigid elongate segment.

7. The collapsible writing board of claim 1, wherein the segment connectors include magnetic strips affixed along a length of at least one face of each rigid elongate segment to allow positioning of the rigid elongate segments into the first and second states.

8. The collapsible writing board of claim 1, wherein the segment connectors include magnetic dots affixed substantially at intervals along a length of at least one face of each rigid elongate segment to allow assembly of the rigid elongate segments into the first and second states.

9. The collapsible writing board of claim 1, wherein the segment connectors include flexible hinges affixed substantially at intervals along a length of at least one face of each rigid elongate segment to allow assembly of the rigid elongate segments into the first and second states.

10. The collapsible writing board of claim 1, wherein the segment connectors include snap hinges affixed substantially at intervals along a length of at least one face of each rigid elongate segment to allow assembly of the rigid elongate segments into the first and second states.

11. A writing board configured to collapse for transport and/or storage, comprising:
a sheet of writing material with a writing surface;
rigid elongate segments including or coupled to the sheet in substantially parallel relationship to one another;
segment connectors coupled between adjacent rigid elongate segments;
wherein the segment connectors are movable between an expanded state wherein the segment connectors support adjacent rigid elongate segments in substantially the same plane such that the writing board can be used and a collapsed state wherein the segment connectors support the adjacent rigid elongate segments in a partially overlapping orientation such that the writing board can be transported and/or stored.

12. The writing board of claim 11, wherein the sheet of writing material includes a flexible material suitable for use with standard dry-erase markers.

13. The writing board of claim 11, further comprising at least one hanger attached to at least one rigid elongate segment, the at least one hanger being configured to suspend the writing board from a structure attached to a vertical support surface.

14. The writing board of claim 13, wherein the at least one hanger includes a hinged hook coupled to a hanger base attached to the at least one rigid elongate segment.

15. The writing board of claim 11, further including at least one hanger formed in at least one rigid elongate segment and having an unhinged hook configured to suspend the writing board from a structure attached to a vertical support surface.

16. The writing board of claim 11, wherein the segment connectors include magnetic strips coupled along a length of at least one face (17) of each rigid elongate segment, adjacent magnetic strips being coupled to one another when the segment connectors are in the expanded state and the adjacent magnetic strips being uncoupled from one another when the segment connectors are in the collapsed state.

17. The writing board of claim 11, wherein the segment connectors include magnetic dots coupled at intervals along a length of at least one face of each rigid elongate segment.

18. A method of using a collapsible writing board, comprising:
unfolding the collapsible writing board from a collapsed state wherein adjacent rigid elongate segments of a plurality of rigid elongate segments coupled to a writing surface are in an at least partially overlapping orientation relative to one another;
bringing the plurality of rigid elongate segments into substantial alignment with one another such that the writing surface is substantially planar; and
folding the collapsible writing board into the collapsed state for transport and/or storage.

19. The method of claim 18, further comprising suspending the collapsible writing board from a vertical support surface after bringing the plurality of rigid elongate segments into substantial alignment

20. The method of claim 18, further comprising placing the collapsible writing board into a storage bag after folding the collapsible writing board into the collapsed state.
